(19) United States
(12) Patent Application Publication
(10) Pub. No.: US 2017/0061794 A1
(43) Pub. Date: Mar. 2, 2017

(54) INFORMATION DISPLAY SYSTEM

(71) Applicant: MITSUBISHI ELECTRIC CORPORATION, Tokyo (JP)

(72) Inventors: Hiroshi NISHIMURA, Tokyo (JP); Takumi AKIYAMA, Tokyo (JP); Hiroshi ASAOKA, Tokyo (JP); Naoki TSURU, Tokyo (JP)

(73) Assignee: MITSUBISHI ELECTRIC CORPORATION, Tokyo (JP)

(21) Appl. No.: 15/308,075

(22) PCT Filed: Nov. 12, 2014
(86) PCT No.: PCT/JP2014/079948

§ 371 Date: Oct. 31, 2016

(30) Foreign Application Priority Data
Jul. 2, 2014 (JP) 2014-136778

(51) Int. Cl. G08G 1/123; B61L 25/02; G06F 3/14

(52) U.S. Cl. CPC G08G 1/123; G06F 3/14; B61L 25/02

(57) ABSTRACT

An operation state acquisition unit 101 acquires the position of a train on a track. A determination unit 102 determines whether the train is traveling as scheduled by comparing the position of the train on the track with the target position of the train on the track if traveled in accordance with the operation schedule. A presentation mode selection unit 103 selects a presentation mode indicating a positional relationship between the train and the target on the track according to a state of being late, early or on time in accordance with the determination result of the determination unit 102. The display unit 104 displays in a representation mode selected by the presentation mode selection unit 103.

### TECHNICAL FIELD

The present invention relates to an information display system for displaying whether or not a transportation object such as a train, expected to travel in accordance with an operation schedule, is traveling as scheduled.

### BACKGROUND ART

To operate trains train operation plans, which are called operation schedules, are prepared in advance. Train drivers operate a train in accordance with such an operation schedule. Conventionally, in order to assist drivers to operate trains as scheduled, there has been provided an assistance system which displays such railway track characteristics as gradient and tunnel existence in combination with a positional relationship between a braking curve and the speed at a current position of a self train (see Patent Literature 1, for example). The system in the prior art aims at enabling the driver to decelerate smoothly before the train reaches a brake start point on the braking curve. In addition, the system in the prior art presents a running curve for on-time running, a maximum speed necessary for on-time running, and an estimated time of arrival if traveled at the current speed, thereby enabling train drivers to foresee an early or delayed arrival, and to accelerate or decelerate the train in order to arrive on time.

### CITATION LIST

### Patent Literature

Patent Literature 1: Japanese Patent Laid-Open No. 2005-231447.

### SUMMARY OF INVENTION

### Technical Problem

According to the configuration described in the foregoing Patent Literature 1, estimated information about an early or delayed arrival is displayed for train drivers. However, there is a problem with the configuration in that they are unable to grasp the displayed information intuitively since the ease of understanding of the displayed information is not taken into consideration.

The present invention has been made to solve the foregoing problem. Accordingly, it is an object of the present invention to provide an information display system that allows for an easy understanding of the degree of being late or early.

### Solution To Problem

An information display system in accordance with the present invention comprises: an operation state acquisition unit to acquire a position on a track of a transportation object expected to travel in accordance with an operation schedule; a determination unit to determine whether or not the transportation object is traveling as scheduled by comparing the position of the transportation object on the track with a target position on the track of the transportation object, the target position reflecting a position the transportation object should be located if traveled in accordance with the operation schedule; a presentation mode selection unit to select a presentation mode for presenting a positional relationship between the transportation object and the target on the track according to being late, early, or on-time, on a basis of the determination result made by the determination unit; and

a display unit to display in the presentation mode selected by the presentation mode selection unit.

### Advantageous Effects of Invention

According to an information display system in accordance with the present invention, a presentation mode that shows the positional relationship on the track between the target and the transportation object is selected in accordance with being late, early or on time. Accordingly, information display system allows for an easy understanding of the degree of being late or early.

### BRIEF DESCRIPTION OF DRAWINGS

FIG. 1 is a block diagram showing an information display system according to Embodiment 1 of the present invention;

FIG. 2 is a flowchart showing the operation of the information display system according to Embodiment 1 of the present invention;

FIGS. 3(a)-(c) are display examples of being late, on time, and early, respectively, provided by the information display system according to Embodiment 1 of the present invention;

FIG. 4 is a block diagram showing an information display system according to Embodiment 2 of the present invention;

FIG. 5 is a flowchart showing the operation of the information display system according to Embodiment 2 of the present invention; and

FIGS. 6(a)-(c) are display examples of being late, on time, and early, respectively, provided by the information display system according to Embodiment 2 of the present invention.

### DESCRIPTION OF EMBODIMENTS

Preferred embodiments for carrying out the invention will now be described with reference to the accompanying drawings to explain the present invention in more detail.

### Embodiment 1

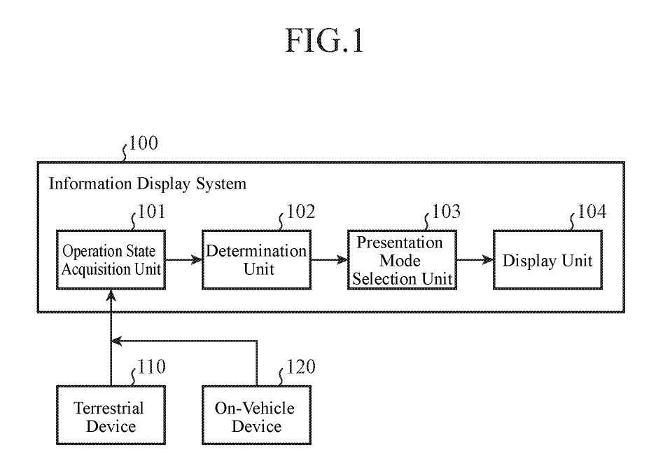

FIG. 1 is a block diagram showing an information display system according to Embodiment 1 of the present invention. In Embodiment 1 a train is used as an example of transportation object.

As shown in FIG. 1, the information display system 100 comprises an operation state acquisition unit 101, a determination unit 102, a presentation mode selection unit 103, and a display unit 104. The operation state acquisition unit 101 is a processing unit that acquires a current time and information about an operation schedule for the train from a terrestrial device 110, and acquires data on a current position of the self vehicle and current operating speed from an on-vehicle device 120. The acquired information and data are sent to the determination unit 102. The information may be obtained from other devices or facilities rather than the external terrestrial device 110 and on-vehicle device 120.

The determination unit 102 is a processing unit that determines if the self vehicle is early or late on the basis of the current time, the operation schedule of the train, and the data on the current position of the self vehicle and the current operating speed, all of which are sent from the operation state acquisition unit 101. The presentation mode selection unit 103 is a processing unit that selects a presentation mode for providing information to the driver. Based on the state information about whether the self vehicle is early or late sent from the determination unit 102, the presentation mode selection unit 103 selects a presentation mode that allows the driver to understand intuitively whether the self vehicle is early or late. The presentation mode and/or selection method of the presentation mode selection unit 103 may be updated or revised by referring to the information, stored in the terrestrial device 110 or on-vehicle device 120, such as “operation plans”, “operation results (including the records of delays, a sudden alteration of operating schedule and the like)” or “self vehicle position”. Alternatively, the presentation mode and/or selection method may be updated or revised by acquiring related information from an external database (not shown) that stores information described above.

The display unit 104 is a display unit for visually showing a target position in conformity with the operation schedule and the position of the train on the track on the basis of the data output from the presentation mode selection unit 103, and is realized by means of a device such as a monitor in the driver's car that the driver can look at, for example.

The information display system 100 is comprised of a computer, and the units 101 to 103 are each implemented by executing software corresponding to their functions by a CPU. Alternatively, any of the units 101 to 103 may be implemented using dedicated hardware.

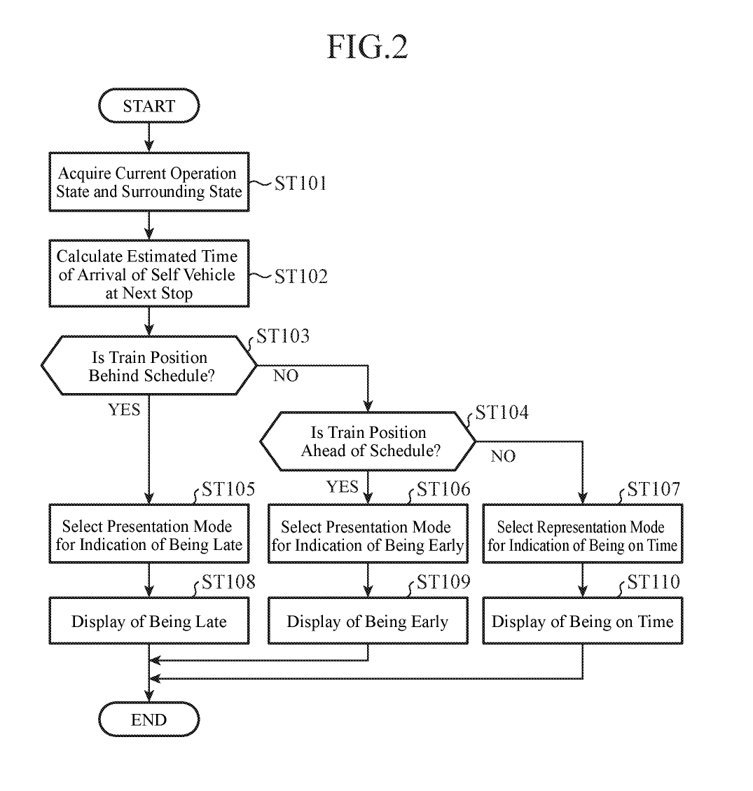

FIG. 2 is a flowchart showing the operation of the information display system 100 according to Embodiment 1, with reference to which its operation will be described below.

The operation state acquisition unit 101 acquires the current time and the operating schedule of the train from the terrestrial device 110, and data on the current position of the self vehicle and the current operating speed from the on-vehicle device 120, and provides the determination unit 102 with the acquired information and data as current operation conditions and surrounding environment conditions (step ST101).

The determination unit 102 calculates first an estimated time of arrival at which the self vehicle will arrive at the next stop on the basis of the data provided from the operation state acquisition unit 101 (step ST102). Next, the determination unit 102 determines whether or not the train position of the self vehicle is behind the operation schedule of the train (step ST103). If the train position is determined to be behind schedule (YES at step ST103), the determination unit 102 outputs information that the estimated time of arrival=−1 minute (being late). On the other hand, if the train position is determined not to be behind schedule at step ST103 (NO at step ST103), the determination unit 102 further determines whether or not the train position is ahead of the operation schedule of the train (step ST104). If the train position is determined to be ahead of schedule (YES at step ST104), the determination unit 102 outputs information that the estimated time of arrival=+1 minute (being early). If the train position is determined not to be ahead of schedule (NO at step ST104), the determination unit 102 outputs information that the estimated time of arrival=0 minute (being on time) since the train is running in accordance with the operation schedule.

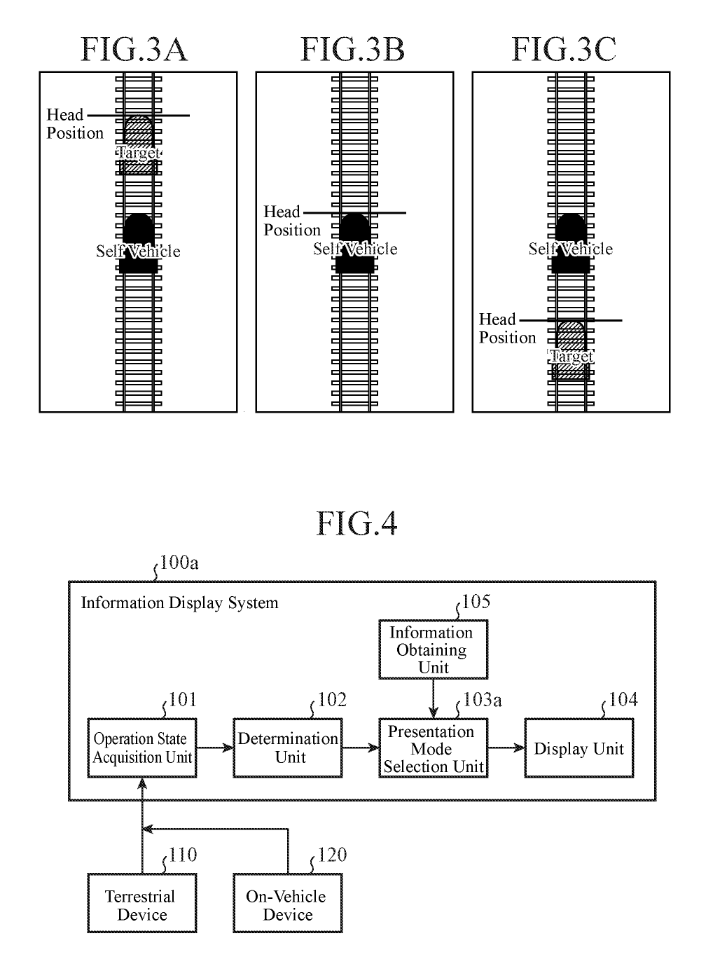

When the determination unit 102 outputs the information that the estimated time of arrival =−1 minute (lagged time), the presentation mode selection unit 103 selects a presentation mode for presenting being late (step ST105). According to this selected presentation mode, the display unit 104 visually displays information that shows the degree to which the self vehicle position is behind the target position on the railway track on the basis of the lagged time (step ST108). FIG. 3(a) is a display example in this case, which shows that the self vehicle is late with respect to the target position (the self vehicle is behind the target). Here, as for the target position and the self vehicle position, the head position of the train is used as the reference. Incidentally, in situations in which an estimated time of arrival is further being delayed, a processing may be made so as to indicate that the self vehicle and the target train are more separated. For example, it is conceivable to widen the display area between them.

When the determination unit 102 outputs the information that the estimated arrival time =+1 minute (led time), the presentation mode selection unit 103 selects a presentation mode for presenting being early (step ST106). According to this selected presentation mode, the display unit 104 visually displays information that shows the degree to which the self vehicle position is ahead of the target position on the railway track on the basis of the led time. FIG. 3(c) is a display example in this case, which shows the self vehicle leads the target position (the self vehicle is positioned ahead of the target). Incidentally, in situations in which an estimated time of arrival is further being early, a processing may be made so as to indicate that the self vehicle and the target train are more separated. For example, it is conceivable to widen the display area between them.

When the determination unit 102 outputs the information that the estimated arrival time=0 minute (normal time), the presentation mode selection unit 103 selects a presentation mode for presenting being on time (step ST107). According to this selected presentation mode, the display unit 104 visually displays the information showing that the target position agrees with the self vehicle position on the railway track (step ST110). FIG. 3(b) is a display example in this case, which shows the target position agrees with the self vehicle position (in FIG. 3(b), the target coincides with the self vehicle).

In this way, according to Embodiment 1, in situations in which the self vehicle is expected to arrive late or early at the next stop, the driver is provided with the information that compares the current position of the self vehicle with the target position of the train based on the operation schedule. As a result, the driver can intuitively understand the information about the degree of being early or late.

As described above, the information display system according to Embodiment 1 comprises: an operation state acquisition unit to acquire a position on a track of a transportation object expected to travel in accordance with an operation schedule; a determination unit to determine whether or not the transportation object is traveling as scheduled by comparing the position of the transportation object on the track with a target position on the track of the transportation object, the target position reflecting a position the transportation object should be located if traveled in accordance with the operation schedule; a presentation mode selection unit to select a presentation mode for presenting a positional relationship between the transportation object and the target on the track according to being late, early, or on-time, on a basis of the determination result made by the determination unit; and a display unit to display in the presentation mode selected by the presentation mode selection unit. Accordingly, the information display system can display information allowing the driver to understand the degree of being early or late.

Further, according to the information display system according to Embodiment 1, since the transportation object and the track are exemplified by a train and a railway track, respectively, the driver of the train can intuitively understand the information about being early or late.

### Embodiment 2

Operations need to be more rigorous if the distance between stops is short. To deal with such a situation, in Embodiment 2 length data of a train are utilized to enable a driver to intuitively understand whether the train is late or early with respect to the operation schedule according to the unit of car. By this, the driver can conduct the operation more punctually.

FIG. 4 is a block diagram showing an information display system 100a according to Embodiment 2. The information display system 100a according to Embodiment 2 comprises the operation state acquisition unit 101, the determination unit 102, a presentation mode selection unit 103a, the display unit 104, and an information obtaining unit 105. The information obtaining unit 105 is a device for obtaining data on the number of cars of the self train and the length of one car, and provides the obtained data to the presentation mode selection unit 103a. These data on the number of cars of the self train and the length of one car may be stored in an information processing unit (not shown) provided outside the train, and the information obtaining unit 105 may obtain the data from such provided information processing unit through wireless communication. These data may be stored in any storage medium or at any venue, and may be obtained through any means. The presentation mode selection unit 103a is configured to set, in the case of being late or early, a presentation mode for showing the relationship between the length of the train and the target position, including the information about the number of cars being late or early, on the basis of the information provided from the information obtaining unit 105. Since the other components in the information display system 100a, the terrestrial device 110, and the on-vehicle device 120 are the same as those of Embodiment 1 shown in FIG. 1, their description will be omitted here.

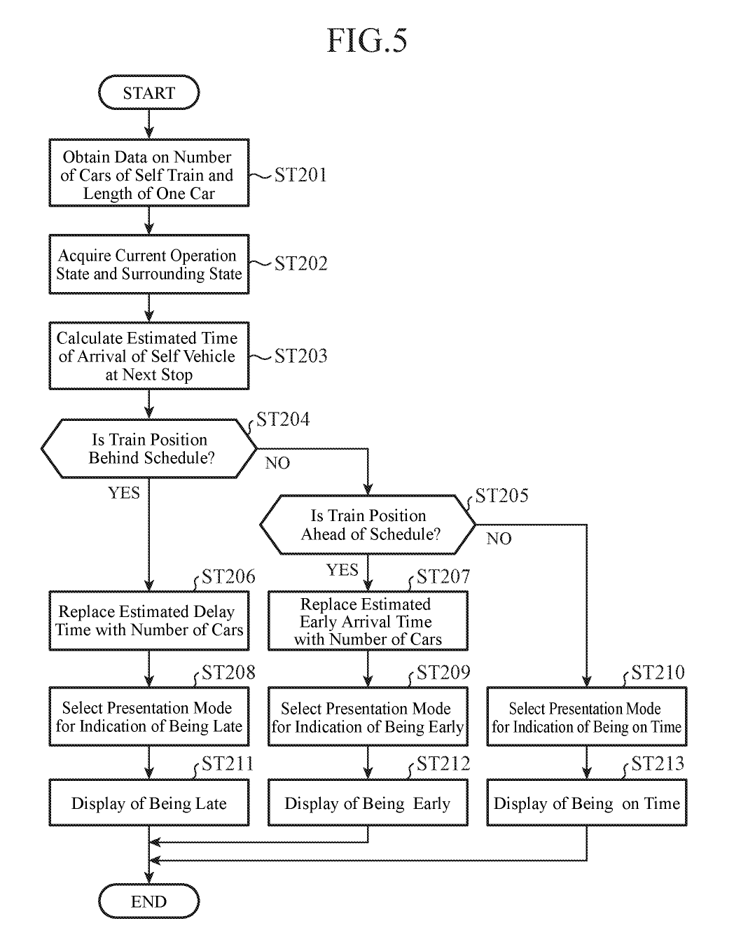

FIG. 5 is a flowchart showing the operation of the information display system 100a according to Embodiment 2. In Embodiment 2, the information obtaining unit 105 obtains data on the number of cars and the length of one car of the train being in operation, and outputs the obtained data to the presentation mode selection unit 103a (step ST201). It is assumed here that the number of cars of the train=15 cars, and that the length of a car=20 m. Incidentally, as for the timing when to obtain the data by the information obtaining unit 105, any timing is feasible as long as it is completed by the time the presentation mode selection unit 103a selects a presentation mode.

The operation state acquisition unit 101 acquires data on the current position of the self vehicle and the current operating speed, and provides the obtained data to the determination unit 102 (step ST202); and the determination unit 102 calculates an estimated time of arrival of the self vehicle arriving at the next stop (step ST203), and determines whether the train position is behind (step ST204) or ahead of the schedule (step ST205). The sequence of processes and decisions at steps ST202-ST205 is the same as that performed at steps ST101-ST104 according to Embodiment 1.

Based on the number of cars of the self train and the length of one car, which are provided from the information obtaining unit 105, and on the estimated delay time, which is provided from the determination unit 102, the presentation mode selection unit 103a computes the delay in terms of the number of cars corresponding to the estimated delay time (steps ST206 and ST207), and selects a presentation mode corresponding to each state (steps ST208-ST210). Next, the display unit 104 performs a display processing in accordance with the presentation mode selected by the presentation mode selection unit 103a in the same manner as in Embodiment 1 (steps ST211-ST213).

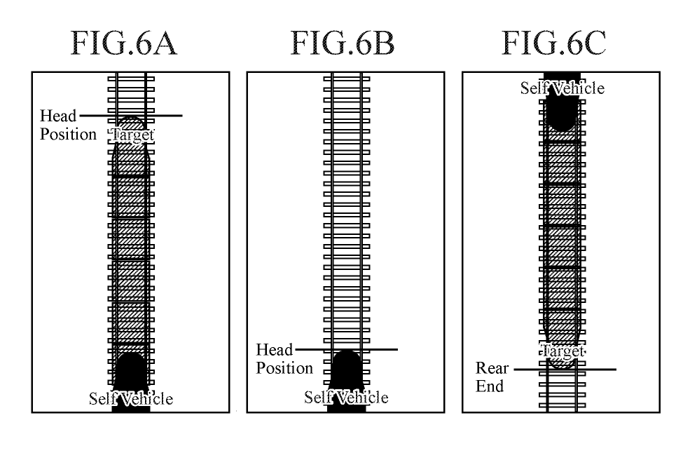

FIG. 6 shows output results by the display unit 104.

FIG. 6(a) depicts a situation in which the determination unit 102 outputs a determination result of being late. For example, the representation mode selection unit 103a calculates as “estimated delay time=delay by five cars” (step ST206), and selects a display mode indicating the five cars delay (step ST208). According to the selected display mode the display unit 104 provides a display in such a manner that the head position of the self vehicle is delayed by five cars from the target. Further, FIG. 6(b) shows a case of being on time, in which the representation mode selection unit 103a selects a presentation mode for indicating being on time (step ST210). According to the selected display mode the display unit 104 provides a display in such a manner that the target and the self vehicle coincide with respect to the head position of the train. Furthermore, FIG. 6(c) shows a case in which the determination unit 102 outputs a determination result of being early. The presentation mode selection unit 103a calculates as “estimated early arrival time=advance by five cars” (step ST207), and selects a display mode showing the five cars advance (step ST209). According to the selected display mode the display unit 104 provides a display. FIG. 6(c) shows that the tail car of the train is early by five cars with respect to the target. Alternatively, another depiction is possible. For example, a display indicating that the head car of the train is ahead of the target by what number of cars is possible.

As described above, the information display system according to Embodiment 2 is configured to comprise the information obtaining unit to obtain a length of the transportation object on the track, and the presentation mode selection unit sets a presentation mode indicating a relationship between the length of the transportation object and the target position on a basis of the information obtained by the information obtaining unit. Accordingly, even when more punctual operation is required, the information display system can display information allowing the driver to understand the degree of being early or late.

Further, the information display system according to Embodiment 2 is configured to comprise the information obtaining unit to obtain the number of cars of the train and a length of one car of the train, and the presentation mode selection unit sets a presentation mode for indicating being delay or early by what number of cars. Accordingly, the information display system enables the driver of the train to understand the information about being early or late intuitively and more accurately.

Incidentally, as for the presentation modes corresponding to being late, early and on-time, although in Embodiments 1 and 2 depictions as shown in FIG. 3 and FIG. 6 are used, other presentation modes such as a letter or character display, a numerical display or a dynamic animation display can also be used.

Although in Embodiments 1 and 2 a train is used as an example of the transportation object, other transportation objects such as a ship, an aircraft, and a motor vehicle including a bus and trailer may be used. In the case of a ship or aircraft, the display unit 104 is embodied as a display device such as a monitor installed in the cockpit. In the case of a motor vehicle, the display unit 104 may be combined with a car navigation system. Whatever a transportation object is, the display unit 104 may be embodied as a display device such as a head-up display (HUD).

Furthermore, the display unit 104 may be a display device installed in an operation control room for controlling and integrating the operation of trains rather than in the driver's car or cockpit of a transportation object, that is, at a location other than a vehicle, ship or aircraft that actually moves. Alternatively, the display unit 104 can be installed in a plurality of locations in a transportation object and other places.

Incidentally, it is to be understood that any combinations of the disclosed embodiments, variations of any components of the disclosed embodiments, and/or removals of any components of the disclosed embodiments may be made within the scope of the present invention.

### INDUSTRIAL APPLICABILITY

An information display system in accordance with the present invention is configured so as to select a presentation mode indicating the positional relationship between the target and the transportation object on the track corresponding to being late, early and on time. Accordingly, the information display system enables a driver to easily understand the degree of being early or late. The system is suitable for a monitor such as installed in the driver's car of a train.

### REFERENCE SIGNS LIST

100, 100a information display system; 101 operation state acquisition unit; 102 determination unit; 103, 103a presentation mode selection unit; 104 display unit; 105 information obtaining unit; 110 terrestrial device; 120 on-vehicle device.

1-4. (canceled)

5. An information display system comprising:
a processor to execute a program; and
a memory to store the program which, when executed by the processor, results in the performance of steps comprising,
acquiring a position on a track of a transportation object expected to travel in accordance with an operation schedule;
determining whether or not the transportation object is traveling as scheduled by comparing the position of the transportation object on the track with a target position on the track of the transportation object, the target position reflecting a position the transportation object should be located if traveled in accordance with the operation schedule;
selecting a presentation mode for presenting a positional relationship between the transportation object and the target on the track according to being late, early, or on-time, on a basis of the determination result; and
obtaining a length of the transportation object on the track,
a display to display in the selected presentation mode, wherein
the processor sets a presentation mode indicating a relationship between the length of the transportation object and the target position on a basis of the obtained information.

6. An information display system comprising:
a processor to execute a program; and
a memory to store the program which, when executed by the processor, results in the performance of steps comprising,
acquiring a position on a track of a transportation object expected to travel in accordance with an operation schedule;
determining whether or not the transportation object is traveling as scheduled by comparing the position of the transportation object on the track with a target position on the track of the transportation object, the target position reflecting a position the transportation object should be located if traveled in accordance with the operation schedule;
selecting a presentation mode for presenting a positional relationship between the transportation object and the target on the track according to being late, early, or on-time, on a basis of the determination result; and
obtaining the number of cars of the train and a length of one car of the train, wherein
the transportation object is a train and the track is a railway track, and
the processor sets a presentation mode for indicating being late or early by what number of cars.
